(19) United States
(12) Patent Application Publication
(10) Pub. No.: US 2023/0117982 A1
(43) Pub. Date: Apr. 20, 2023

(54) METHOD FOR ENHANCING BATTERY CYCLE PERFORMANCE AND ELECTRONIC DEVICE

(71) Applicant: Ningde Amperex Technology Limited, Ningde City, Fujian Province (CN)

(72) Inventors: Zhanzhao Fang, Ningde City (CN); Hui Cui, Ningde City (CN); Hanxiang Zhang, Ningde City (CN)

(73) Assignee: Ningde Amperex Technology Limited, Ningde City, Fujian Province (CN)

(21) Appl. No.: 17/795,927

(22) PCT Filed: Mar. 26, 2020
(86) PCT No.: PCT/CN2020/081496

§ 371 Date: Jul. 28, 2022

(51) Int. Cl. H01M 10/0567; H02J 7/00; H01M 10/44

(52) U.S. Cl. CPC H01M 10/0567; H02J 7/007182; H01M 10/44; H01M 2300/0025

(57) ABSTRACT

A method for enhancing battery cycle performance is applied in a battery and includes the following steps: charging, at a first stage, the battery at a first-stage current until reaching a first-stage voltage; and charging, at a second stage, the battery at a second-stage current until reaching a second-stage voltage. The second-stage voltage is greater than the first-stage voltage. The second-stage current is less than the first-stage current. The battery includes an electrolytic solution containing an additive. The additive includes a nitrile compound. A mass percent of the nitrile compound in the electrolytic solution is 0.5% to 5%. This application further provides an electronic device. The method and electronic device according to this application can enhance high-temperature cycle performance of the battery, reduce a high-temperature storage expansion rate, and enhance hot-oven safety performance.

### CROSS-REFERENCES

This present application is a national phase application of PCT application PCT/CN2020/081496, filed on Mar. 26, 2020, the disclosure of which is hereby incorporated by reference in its entirety.

### TECHNICAL FIELD

This application relates to the technical field of batteries, and in particular, to a method for enhancing battery cycle performance and an electronic device.

### BACKGROUND

Currently, by virtue of advantages such as a high energy density, a high power density, reusability for a large number of cycles, and a long shelf life, a lithium-ion battery embraces a prospect of wide use in large and medium-sized electric equipment such as electric means of transport and energy storage facilities. Therefore, the lithium-ion battery has become a crux for solving global problems such as energy crisis and environmental pollution.

Existing charging methods for lithium-ion batteries are constant-current charging and constant-voltage charging. The constant-current charging means that, at the start of charging, the lithium-ion battery is charged at a constant current until the voltage reaches a specified voltage value. The constant-voltage charging means that, after the lithium-ion battery is charged to the specified voltage value, the lithium-ion battery is charged at a constant voltage until the battery is fully charged. However, in the existing charging method for the lithium ion battery, a positive electrode potential is relatively high at the end of the full charge, and the high-potential status lasts for a relatively long time. Therefore, the existing charging method for the lithium-ion battery causes damage to a positive electrode material of the lithium-ion battery, thereby not only affecting high-temperature cycle performance of the lithium-ion battery, but also increasing a high-temperature storage expansion rate and reducing hot-oven safety performance.

### SUMMARY

In view of this, it is necessary to provide a method for enhancing battery cycle performance and an electronic device, so that the method and electronic device can enhance high-temperature cycle performance of a battery, reduce a high-temperature storage expansion rate, and enhance hot-oven safety performance.

An embodiment of this application provides a method for enhancing battery cycle performance. The method is applied in a battery, and includes the following steps:
charging, at a first stage, the battery at a first-stage current until reaching a first-stage voltage; and
charging, at a second stage, the battery at a second-stage current until reaching a second-stage voltage, where the second-stage voltage is greater than the first-stage voltage, and the second-stage current is less than the first-stage current,
where, the battery includes an electrolytic solution containing an additive, the additive includes a nitrile compound, and a mass percent of the nitrile compound in the electrolytic solution is 0.5% to 5%.

According to some embodiments of this application, the additive includes a nitrile compound represented by Structural Formula 1:

NC—R₁₁—CN Formula 1

In Formula 1, R₁₁ is selected from substituted or unsubstituted C₁ to C₁₀ alkylidene or C₁ to C₁₀ alkyleneoxy.

According to some embodiments of this application, the additive includes a nitrile compound represented by Structural Formula 2:

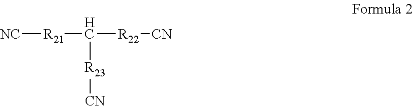

In Formula 2, R₂₁, R₂₂, and R₂₃ each are independently selected from substituted or unsubstituted C₀ to C₁₀ alkylidene or C₁ to C₁₀ alkyleneoxy.

According to some embodiments of this application, the additive includes a nitrile compound represented by Structural Formula 3:

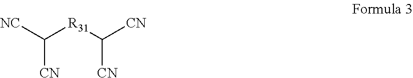

In Formula 3, R₃₁ is selected from substituted or unsubstituted C₁ to C₅ alkyl, substituted or unsubstituted C₂ to C₁₀ alkenyl, substituted or unsubstituted C₆ to C₁₀ aryl, or, substituted or unsubstituted C₁ to C₆ heterocyclic group, of which a substituent is a halogen atom or at least one of nitro, cyano, carboxyl, or sulfate group.

According to some embodiments of this application, at the second stage, the battery is charged in a first charging manner or a second charging manner until reaching the second-stage voltage.

The first charging manner includes K sequential sub-stages, where K is an integer greater than or equal to 2, the K sub-stages are defined as an i^{th} sub-stage, where i=1, 2, . . . K, respectively; at the i^{th} sub-stage, the battery is charged at an i^{th} current or an i^{th} voltage or an i^{th} power; at an (i+1)^{th} sub-stage, the battery is charged at an (i+1)^{th} current or an (i+1)^{th} voltage or an (i+1)^{th} power; and, a charge current at the (i+1)^{th} sub-stage is less than or equal to the charge current at the i^{th} sub-stage, or the (i+1)^{th} voltage is greater than or equal to the i^{th} voltage, or the (i+1)^{th} power is less than or equal to the i^{th} power.

The second charging manner includes D sequential charging sub-stages, where D is an integer greater than or equal to 2, the D charging sub-stages are defined as a j^{th} charging sub-stage, where j=1, 2, . . . D, respectively, each j^{th} charging sub-stage includes a j^{th} earlier charging sub-stage and a j^{th} later charging sub-stage; at one of the j^{th} earlier charging sub-stage or the j^{th} later charging sub-stage, the battery is not charged or is charged or discharged at a j^{th} earlier charge sub-current for a duration of Tj1; at the other of the j^{th} earlier charging sub-stage or the j^{th} later charging sub-stage, the battery is charged at a j^{th} later charge sub-current for a duration of Tj2; and an absolute value of the j^{th} earlier charge sub-current is less than an absolute value of the j^{th} later charge sub-current.

According to some embodiments of this application, in a case that, at the second stage, the battery is charged in the second charging manner until reaching the second-stage voltage, an average value of the charge current at the j^{th} charging sub-stage is less than the charge current at the first stage, and an average value of the charge current at the (j+1)^{th} charging sub-stage is less than or equal to the charge current at the j^{th} charging sub-stage.

According to some embodiments of this application, at the first stage, the battery is charged in a third charging manner until reaching the first-stage voltage, and the third charging manner adopts the first charging manner or the second charging manner.

According to some embodiments of this application, when the third charging manner adopts the first charging manner, the number K of charging sub-stages is identical between the two manners; or, when the third charging manner adopts the second charging manner, the number D of charging sub-stages is identical between the two manners.

According to some embodiments of this application, the first-stage voltage is equal to a charge voltage limit of the battery, and the second-stage voltage is less than an oxidative decomposition voltage of the electrolytic solution in the battery.

According to some embodiments of this application, the second-stage voltage is less than or equal to the first-stage voltage plus 500 millivolts.

According to some embodiments of this application, at the third stage, the battery is charged at a constant voltage equal to the second-stage voltage.

An embodiment of this application provides an electronic device. The electronic device includes a battery and a battery management unit. The battery includes an electrolytic solution containing an additive. The additive includes a nitrile compound. A mass percent of the nitrile compound in the electrolytic solution is 0.5% to 5%. The battery management unit is configured to execute the method for enhancing battery cycle performance.

In the method for enhancing battery cycle performance according to the embodiments of this application, the charge voltage of the battery is increased from the first-stage voltage to the second-stage voltage. In addition, a nitrile compound is added into the electrolytic solution at a given mass percent, thereby enhancing the high-temperature cycle performance of the battery while reducing the high-temperature storage expansion rate and enhancing hot-oven safety performance.

### BRIEF DESCRIPTION OF DRAWINGS

FIG. 1 is a schematic diagram of an electronic device according to an embodiment of this application;

FIG. 2 is a flowchart of a method for enhancing battery cycle performance according to an embodiment of this application;

FIG. 3 is a first specific embodiment of the method for enhancing battery cycle performance shown in FIG. 2;

FIG. 4 is a schematic diagram of time-varying current and voltage of a battery during charging according to a first embodiment of this application;

FIG. 5 is a schematic diagram of time-varying current and voltage of a battery during charging according to a second embodiment of this application;

FIG. 6 is a schematic diagram of time-varying power and voltage at a first stage and time-varying current and voltage at a second stage according to an embodiment of this application;

FIG. 7 is a schematic diagram of time-varying current and voltage of a battery during charging according to a third embodiment of this application;

FIG. 8 is a schematic diagram of time-varying current and voltage of a battery during charging according to a fourth embodiment of this application;

FIG. 9 is a second specific embodiment of the method for enhancing battery cycle performance shown in FIG. 2;

FIG. 10 is a third specific embodiment of the method for enhancing battery cycle performance shown in FIG. 2; and

FIG. 11 is a fourth specific embodiment of the method for enhancing battery cycle performance shown in FIG. 2.

### REFERENCE NUMERALS OF MAIN COMPONENTS

Electronic device 1
Battery 10
Control unit 11
Battery management unit 12

### DETAILED DESCRIPTION OF EMBODIMENTS

The following describes the technical solutions in the embodiments of this application clearly and thoroughly with reference to the drawings herein. Evidently, the described embodiments are merely a part of but not all of the embodiments of this application.

All other embodiments derived by a person of ordinary skill in the art based on the embodiments of the present invention without making any creative effort fall within the protection scope of the present invention.

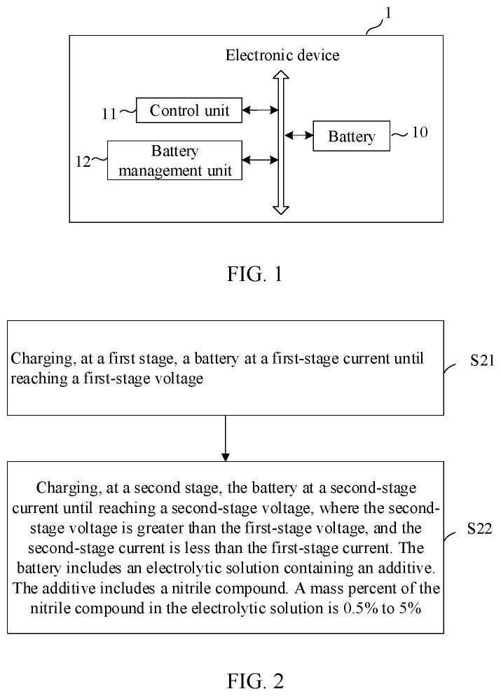

Referring to FIG. 1, FIG. 1 is a schematic diagram of an electronic device according to an embodiment of this application. A method for enhancing battery cycle performance is applied in an electronic device 1. The electronic device 1 includes a battery 10, a control unit 11, and a battery management unit 12. The battery 10, the control unit 11, and the battery management unit 12 may be interconnected by a bus or directly. The battery 10 is a rechargeable battery. The battery 10 includes at least one cell. The battery 10 can be repeatedly charged in a rechargeable manner.

The control unit 11 can control the battery management unit 12 to execute the method for enhancing battery cycle performance. The control unit 11 may be a microcontroller unit (Microcontroller, MCU), a processor (Processor), an application-specific integrated circuit (Application-specific integrated circuit, ASIC), or the like, and can control the battery management unit 12 to execute the method for enhancing battery cycle performance.

It needs to be noted that FIG. 1 describes merely an example of the electronic device 1. In other embodiments, the electronic device 1 may include more or fewer components, or may be equipped with different components. The electronic device 1 may be an electric motorcycle, an electric bicycle, an electric vehicle, a mobile phone, a tablet computer, a personal digital assistant, a personal computer, or any other rechargeable devices as appropriate.

The electronic device 1 may further include other components that are not shown though, such as a wireless fidelity (Wireless Fidelity, WiFi) unit, a Bluetooth unit, a speaker, details of which are omitted here.

Referring to FIG. 2, FIG. 2 is a flowchart of a method for enhancing battery cycle performance according to an embodiment of this application. The method for enhancing battery cycle performance is applied to a battery. The battery is a rechargeable battery. For example, the battery may be a lead-acid battery, nickel-cadmium battery, nickel-hydrogen battery, lithium-ion battery, lithium polymer battery, lithium iron phosphate battery, or the like. The battery includes a cell. The battery can be repeatedly charged in a rechargeable manner. In this embodiment, the battery 10 primarily includes a positive electrode plate, a negative electrode plate, a separator, an electrolytic solution, and a packaging bag. The method for enhancing battery cycle performance includes the following steps:

S21: Charging, at a first stage, the battery at a first-stage current until reaching a first-stage voltage; and

S22: Charging, at a second stage, the battery at a second-stage current until reaching a second-stage voltage, where the second-stage voltage is greater than the first-stage voltage, and the second-stage current is less than the first-stage current.

The battery includes an electrolytic solution containing an additive. The additive includes a nitrile compound. In an embodiment, a mass percent of the nitrile compound in the electrolytic solution is 0.5% to 5%. In another embodiment, the mass percent of the nitrile compound in the electrolytic solution is 0.5% to 3%.

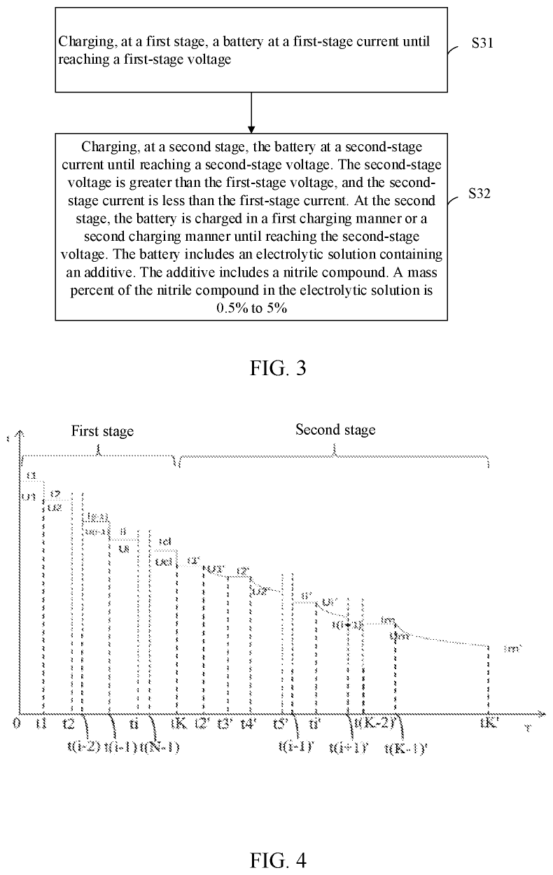

Referring to FIG. 3, FIG. 3 is a first specific embodiment of the method for enhancing battery cycle performance shown in FIG. 2. The method includes the following steps.

S31: Charging, at a first stage, the battery at a first-stage current until reaching a first-stage voltage.

In this embodiment, the first-stage current is a constant current, and specifically, a constant current at which the battery is charged at the start of an existing charging process. Alternatively, the first-stage current may be a varying current. For example, at the first stage, the battery is charged at a constant voltage, and therefore, the charge current corresponding to the constant voltage (that is, the first-stage current) is variable as long as the battery can be charged to reach the first-stage voltage by using the first-stage current. The first-stage voltage is equal to a charge voltage limit of the battery (which may be understood as a well-known charge voltage limit).

S32: Charging, at a second stage, the battery at a second-stage current until reaching a second-stage voltage. The second-stage voltage is greater than the first-stage voltage, and the second-stage current is less than the first-stage current. At the second stage, the battery is charged in a first charging manner or a second charging manner until reaching the second-stage voltage.

The battery includes an electrolytic solution containing an additive. The additive includes a nitrile compound. A mass percent of the nitrile compound in the electrolytic solution is 0.5% to 5%.

In some embodiments, the mass percent of the nitrile compound in the electrolytic solution is 0.5% to 3%.

In this embodiment, the first charging manner includes K sequential sub-stages, where K is an integer greater than or equal to 2. The K sub-stages are defined as an i^{th} sub-stage, where i=1, 2, . . . K, respectively. At the i^{th} sub-stage, the battery is charged at an i^{th} current or an i^{th} voltage or an i^{th} power. At an (i+1)^{th} sub-stage, the battery is charged at an (i+1)^{th} current or an (i+1)^{th} voltage or an (i+1)^{th} power. In an embodiment, the charge current at the (i+1)^{th} sub-stage is less than or equal to the charge current at the i^{th} sub-stage. In another embodiment, the (i+1)^{th} voltage is greater than or equal to the i^{th} voltage. In another embodiment, the (i+1)^{th} power is less than or equal to the i^{th} power.

the second charging manner includes D sequential charging sub-stages, where D is an integer greater than or equal to 2, the D charging sub-stages are defined as a j^{th} charging sub-stage, where j=1, 2, . . . D, respectively, each j^{th} charging sub-stage includes a j^{th} earlier charging sub-stage and a j^{th} later charging sub-stage; at one of the j^{th} earlier charging sub-stage or the j^{th} later charging sub-stage, the battery is not charged or is charged or discharged at a j^{th} earlier charge sub-current for a duration of Tj1; at the other of the j^{th} earlier charging sub-stage or the j^{th} later charging sub-stage, the battery is charged at a j^{th} later charge sub-current for a duration of Tj2; and an absolute value of the j^{th} earlier charge sub-current is less than an absolute value of the j^{th} later charge sub-current.

In this embodiment, the average of the charge current at the (j+1)^{th} charging sub-stage is less than or equal to the charge current at the j^{th} charging sub-stage, and, when the third charging manner adopts the second charging manner, the average of the charge current at the j^{th} charging sub-stage is less than the charge current in the first charging manner or the second charging manner.

It needs to be noted that the first-stage voltage is equal to a charge voltage limit of the battery.

The charge current at the 1^{st} charging sub-stage of the second stage is less than the first-stage current, and the charge current at the (i+1)^{th} charging sub-stage is less than or equal to the charge current at the i^{th} charging sub-stage, thereby making a negative electrode potential of the battery be not lower than a negative electrode lithium plating potential.

The lithium plating potential may be obtained by the following test. For the battery in this embodiment, another three-electrode battery of the same specifications is made. Compared with the battery in this embodiment, the three-electrode battery includes an additional electrode, and specifically, includes three electrodes: negative electrode, positive electrode, and reference electrode. The material of the reference electrode is lithium, and the three-electrode battery is configured for testing to obtain the lithium plating potential of the negative electrode of the battery in this embodiment.

The specific test method for the lithium plating potential of the negative electrode is: making a plurality of three-electrode batteries, charging and discharging the three-electrode batteries at charge currents of different rates (for example, 1C, 2C, and 3C) respectively for a plurality of cycles (for example, 10 cycles), and detecting a potential difference between the negative electrode and the reference electrode in the charge-and-discharge process; subsequently, disassembling each three-electrode battery in a fully charged state, and checking whether lithium plating occurs on the negative electrodes of the three-electrode batteries charged at different rates (that is, checking whether metallic lithium is precipitated on the surface of the negative electrode); determining a maximum C-rate corresponding to a three-electrode battery free from lithium plating, and using a minimum value of a potential difference between the negative electrode and the reference electrode obtained in a process of charging and discharging at such a C-rate as the lithium plating potential of the negative electrode. In addition, it needs to be noted that the charge current of a lithium battery is generally represented by a value relative to a rate of C, where C is a numerical value corresponding to the capacity of the lithium battery. The capacity of a lithium battery is generally expressed in Ah or mAh. For example, when the battery capacity is 1200 mAh, 1 C is 1200 mA, and 0.2 C is equal to 240 mA.

For another example, a plurality of three-electrode batteries are charged and discharged at charge currents of 1 C, 2 C, and 3 C, respectively, for 10 cycles. As shown by the three-electrode batteries disassembled, the negative electrode of the batteries charged and discharged at a current of 1 C or 2 C is free from lithium plating, but the negative electrode of the batteries charged and discharged at a current of 3 C incurs lithium plating. Therefore, a minimum value of the potential difference between the negative electrode and the reference electrode obtained in a process of charging and discharging at a 2 C rate is the lithium plating potential of the negative electrode. In addition, the lithium plating potential of the positive electrode may also be tested in a similar manner, details of which are omitted here. As observed in the process of testing the lithium plating potential of the negative electrode, the negative electrode potential and positive electrode potential of the battery are further understood as follows: the negative electrode potential is a potential difference between the negative electrode and the reference electrode, that is, a potential versus Li/Li⁺ of the negative electrode; and the positive electrode potential is a potential difference between the positive electrode and the reference electrode, that is, a potential versus Li/Li⁺ of the positive electrode.

The second-stage voltage is less than an oxidative decomposition voltage of the electrolytic solution in the battery. The oxidative decomposition voltage of the electrolytic solution in the battery may be understood as follows: when the potential of the battery exceeds a potential threshold, irreversible reduction or oxidative decomposition reactions of the solvent molecules, additive molecules, and even impurity molecules in the electrolytic solution will occur on an interface between the electrode and the electrolytic solution. This phenomenon is referred to as electrolytic solution decomposition. The potential threshold is a reduction decomposition voltage and an oxidative decomposition voltage of the electrolytic solution in the battery, that is, the oxidative decomposition voltage of the electrolytic solution in the battery. The oxidative decomposition voltage of the electrolytic solution can be obtained in any way currently available.

In this embodiment, the second-stage voltage is further less than or equal to the first-stage voltage plus 500 millivolts. In the K^{th} charging sub-stage or the D^{th} charging sub-stage of the second stage, the battery is charged until the voltage reaches the second-stage voltage. At this time, a charge cut-off condition of the battery may be a cut-off voltage, cut-off current, or cut-off capacity. More specifically, in the K^{th} charging sub-stage or the D^{th} charging sub-stage, the charging of the battery stops and the charging is cut off when the charge current of the battery is equal to the cut-off current, or the reached charge voltage (that is, a voltage difference between the positive electrode and the negative electrode) is equal to the cut-off voltage, or a capacitance of the battery is equal to the cut-off capacity. For batteries of different specifications, the cut-off current, cut-off voltage, and cut-off capacity can be obtained in any way of testing currently available by observing that the positive electrode of the battery is free from over-delithiation, so as to ensure that the capacitance of the battery is equivalent to the capacitance obtained in a conventional charging manner in the prior art, and to ensure that the positive electrode of the battery is free from over-delithiation.

In addition, it needs to be noted that: in this embodiment, the following values may be pre-stored in the battery or a processor 11: the first-stage current; the first-stage voltage; one of the i^{th} current, the i^{th} voltage, or the i^{th} power at the i^{th} charging sub-stage of the first stage; one of the i^{th} current, the i^{th} voltage, or the i^{th} power at the i^{th} charging sub-stage of the second stage; the second-stage voltage; and the cut-off condition. The processor 11 reads the pre-stored values to correctly control the charging system 10 to perform charging.

Referring to FIG. 4, at the first stage, the battery is charged in the first charging manner, the first charging manner includes K sequential charging sub-stages, and the K charging sub-stages are defined as an i^{th} charging sub-stage, where i=1, 2, . . . , K, respectively; and, at the i^{th} charging sub-stage, the battery is charged at an i^{th} current. At the second stage, the battery is charged in the first charging manner, the first charging manner includes K sequential charging sub-stages, and the K charging sub-stages are defined as the i^{th} charging sub-stage, where i=1, 2, . . . K, respectively; at the i^{th} charging sub-stage, the battery is charged at the i^{th} current; at the (i+1)^{th} charging sub-stage, the battery is charged at an i^{th} voltage, and the charging process goes on alternately and cyclically in this way.

At the first stage, in a period between time 0 and t1, the battery is charged at a constant current of I1 until the voltage reaches U1; in a period between time t1 and t2, the battery is charged at a constant current of I2 until the voltage reaches U2; in a period between time t(i−2) and t(i−1), the battery is charged at a constant current of I(i−1) until the voltage reaches U(i−1); in a period between time t(i−1) to ti, the battery is charged at a constant current of Ii until the voltage reaches Ui; and, in a period between time t(K−1) and tK, the battery is charged at a constant current of Ic1 until the voltage reaches Uc1. A similar charging process is performed in a period between time t2 and t(i−2), and in a period between time ti and t(K−1), which is omitted from the drawing and not shown.

At the second stage, in a period between time t1′ and t2′, the battery is charged at a constant current of I1′ until the voltage reaches U1′; in a period between time t2′ and t3′, the battery is charged at a constant voltage of U1′, and the corresponding charge current in this period drops from I1′ to I2′; in a period between time t3′ and t4′, the battery is charged at a constant current of I2′ until the voltage reaches U2′; in a period between time t4′ and t5′, the battery is charged at a constant voltage of U2; in a period between time t(i−1)′ and ti′, the battery is charged at a constant current of Ii′ until the voltage reaches Ui; in a period between time ti′ and t(i+1)′, the battery is charged at a constant voltage of Ui′, and the corresponding charge current in this period drops from I1′ to I(i+1); in a period between time t(K−2)′ and t(K−1)′, the battery is charged at a constant current of Im until the voltage reaches Um; and, in a period between time t(K−1)′ and tK′, the battery is charged at a constant voltage of Um, and the corresponding charge current in this period drops from Im to Im′. A similar charging process is performed in a period between time t5′ and t(i−1)′, and in a period between time t(i+1)′ and t(K−1)′, which is omitted from the drawing and not shown.

It needs to be noted that tK and t1′ are the same time. At each of the K charging sub-stages of the first stage, the battery is charged at a constant charge current, I1≥I2≥ . . . ≥Ic1, and U1≤U2≤ . . . ≤Uc1. At each of the K charging sub-stages of the second stage, the battery is charged at a constant current and a constant voltage alternately, Ic1≥I1′≥I2′≥ . . . ≥Im′, and Uc1≤U1′≤U2′≤ . . . ≤Um.

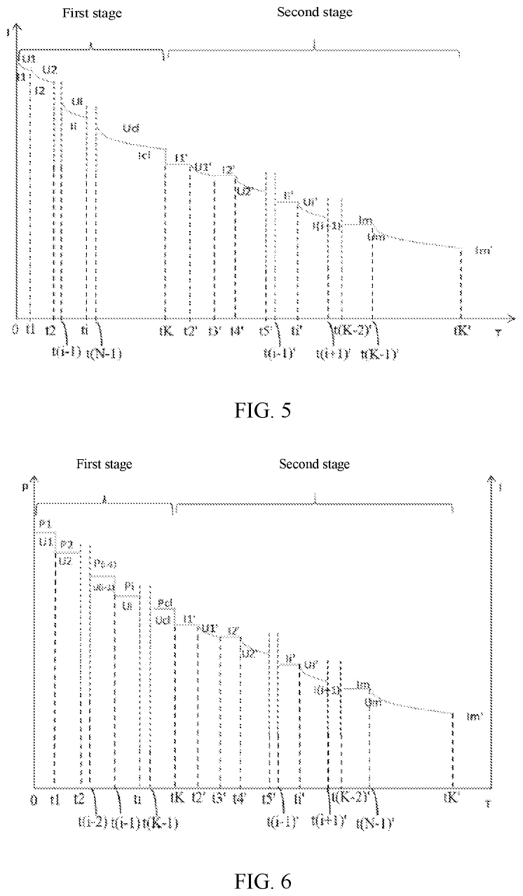

Referring to FIG. 5, at the first stage, the battery is charged in the first charging manner, the first charging manner includes K sequential charging sub-stages, and the K charging sub-stages are defined as an i^{th} charging sub-stage, where i=1, 2, . . . , K, respectively; and, at the i^{th} charging sub-stage, the battery is charged at the i^{th} voltage. At the second stage, the battery is charged in the first charging manner, the first charging manner includes K sequential charging sub-stages, and the K charging sub-stages are defined as the i^{th} charging sub-stage, where i=1, 2, . . . K, respectively; at the i^{th} charging sub-stage, the battery is charged at the i^{th} current; at the (i+1)^{th} charging sub-stage, the battery is charged at the i^{th} voltage, and the charging process goes on alternately and cyclically in this way.

At the first stage, in a period between time 0 and t1, the battery is charged at a constant voltage of U1 until the current reaches I1; in a period between time t1 and t2, the battery is charged at a constant voltage of U2 until the current reaches I2; in a period between time t(i−1) and ti, the battery is charged at a constant voltage of Ui until the current reaches Ii; and, in a period between time t(K−1) and tK, the battery is charged at a constant voltage of Uc1 until the current reaches Ic1. A similar charging process is performed in a period between time t2 and t(i−1), and in a period between time ti and t(K−1), which is omitted from the drawing and not shown.

At the second stage, in a period between time t1′ and t2′, the battery is charged at a constant current of I1′ until the voltage reaches U1′; in a period between time t2′ and t3′, the battery is charged at a constant voltage of U1′, and the corresponding charge current in this period drops from I1′ to I2′; in a period between time t3′ and t4′, the battery is charged at a constant current of I2′ until the voltage reaches U2′; in a period between time t4′ and t5′, the battery is charged at a constant voltage of U2; in a period between time t(i−1)′ and ti′, the battery is charged at a constant current of Ii′ until the voltage reaches Ui; in a period between time ti′ and t(i+1)′, the battery is charged at a constant voltage of Ui′, and the corresponding charge current in this period drops from Ii′ to I(i+1)′; in a period between time t(K−2)′ and t(K−1)′, the battery is charged at a constant current of Im until the voltage reaches Um; and, in a period between time t(K−1)′ and tK′, the battery is charged at a constant voltage of Um, and the corresponding charge current in this period drops from Im to Im′. A similar charging process is performed in a period between time t5′ and t(i−1)′, and in a period between time t(i+1)′ and t(K−2)′, which is omitted from the drawing and not shown.

It needs to be noted that tK and t1′ are the same time. At each of the K charging sub-stages of the first stage, the battery is charged at a constant charge voltage, U1≤U2≤ . . . ≤Uc1, and I1≥I2≥ . . . ≥Ic1. At each of the K charging sub-stages of the second stage, the battery is charged at a constant charge current and a constant charge voltage alternately, Uc1≤U1′≤U2′≤ . . . ≤Um, and Ic1≥I1′≥I2′≥ . . . ≥Im′.

Referring to FIG. 6, at the first stage, the battery is charged in the first charging manner, the first charging manner includes K sequential charging sub-stages, and the K charging sub-stages are defined as an i^{th} charging sub-stage, where i=1, 2, . . . , K, respectively; and, at the i^{th} charging sub-stage, the battery is charged at the i^{th} power. At the second stage, the battery is charged in the first charging manner, the first charging manner includes K sequential charging sub-stages, and the K charging sub-stages are defined as the i^{th} charging sub-stage, where i=1, 2, . . . K, respectively; at the i^{th} charging sub-stage, the battery is charged at the i^{th} current; at the (i+1)^{th} charging sub-stage, the battery is charged at an i^{th} voltage, and the charging process goes on alternately and cyclically in this way.

At the first stage, in a period between time 0 and t1, the battery is charged at a constant power of P1 until the voltage reaches U1; in a period between time t1 and t2, the battery is charged at a constant power of P2 until the voltage reaches U2; in a period between time t(i−2) and t(i−1), the battery is charged at a constant power of P(i−1) until the voltage reaches U(i−1); in a period between time t(i−1) to ti, the battery is charged at a constant power of Pi until the voltage reaches Ui; and, in a period between time t(K−1) and tK, the battery is charged at a constant power of Pc1 until the voltage reaches Uc1. A similar charging process is performed in a period between time t2 and t(i−2), and in a period between time ti and t(K−1), which is omitted from the drawing and not shown.

At the second stage, in a period between time t1′ and t2′, the battery is charged at a constant current of I1′ until the voltage reaches U1′; in a period between time t2′ and t3′, the battery is charged at a constant voltage of Ur, and the corresponding charge current in this period drops from I1′ to I2′; in a period between time t3′ and t4′, the battery is charged at a constant current of I2′ until the voltage reaches U2′; in a period between time t4′ and t5′, the battery is charged at a constant voltage of U2; in a period between time t(i−1)′ and ti′, the battery is charged at a constant current of Ii′ until the voltage reaches Ui′; in a period between time ti′ and t(i+1)′, the battery is charged at a constant voltage of Ui′, and the corresponding charge current in this period drops from I1′ to I(i+1)′; in a period between time t(K−2)′ and t(K−1)′, the battery is charged at a constant current of Im until the voltage reaches Um; and, in a period between time t(K−1)′ and tK′, the battery is charged at a constant voltage of Um, and the corresponding charge current in this period drops from Im to Im′. A similar charging process is performed in a period between time t5′ and t(i−1)′, and in a period between time t(i+1)′ and t(K−2)′, which is omitted from the drawing and not shown.

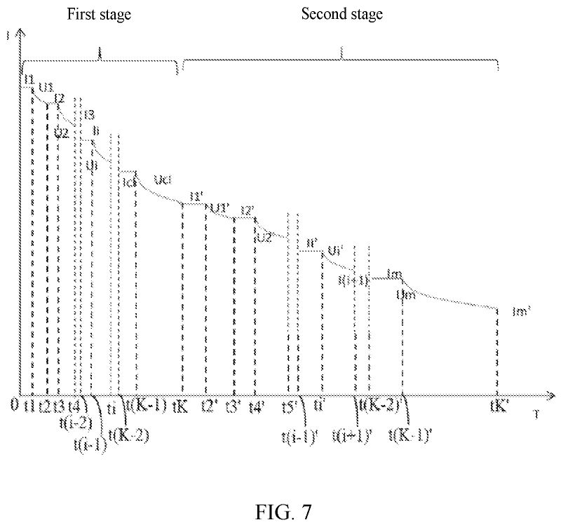

It needs to be noted that, at each of the K charging sub-stages of the first stage, the battery is charged at a constant power, P1≥P2≥ . . . ≥Pc1, and U1≤U2≤ . . . ≤Uc1. At each of the K charging sub-stages of the second stage, the battery is charged at a constant charge current and a constant charge voltage alternately, Uc1≤U1′≤U2′≤ . . . ≤Um, and Ic1≥I1′≥I2′≥ . . . ≥Im′. Referring to FIG. 7, at the first stage, the battery is charged in the first charging manner, the first charging manner includes K sequential charging sub-stages, and the K charging sub-stages are defined as the i^{th} charging sub-stage, where i=1, 2, . . . K, respectively; at the i^{th} charging sub-stage, the battery is charged at the i^{th} current; at the (i+1)^{th} charging sub-stage, the battery is charged at the i^{th} voltage, and the charging process goes on alternately and cyclically in this way. At the second stage, the battery is charged in the first charging manner, the first charging manner includes K sequential charging sub-stages, and the K charging sub-stages are defined as the i^{th} charging sub-stage, where i=1, 2, . . . K, respectively; at the i^{th} charging sub-stage, the battery is charged at the i^{th} current; at the (i+1)^{th} charging sub-stage, the battery is charged at an i^{th} voltage, and the charging process goes on alternately and cyclically in this way.

At the first stage, in a period between time 0 and t1, the battery is charged at a constant current of I1 until the voltage reaches U1; in a period between time t1 and t2, the battery is charged at a constant voltage of U1, and the corresponding charge current in this period drops from I1 to I2; in a period between time t2 and t3, the battery is charged at a constant current of I2 until the voltage reaches U2; in a period between time t3 and t4, the battery is charged at a constant voltage of U2, and the corresponding charge current in this period drops from I2 to I3; in a period between time t(i−2) and t(i−1), the battery is charged at a constant current of Ii until the voltage reaches Ui; in a period between time t(i−1) and ti, the battery is charged at a constant voltage of Ui; in a period between time t(K−2) and t(K−1), the battery is charged at a constant current of Ic1 until the voltage reaches Uc1; and, in a period between time t(K−1) and tK, the battery is charged at a constant voltage of Uc1, and the corresponding charge current in this period drops from Ic1 to IP. A similar charging process is performed in a period between time t4 and t(i−2), and in a period between time ti and t(K−2), which is omitted from the drawing and not shown.

At the second stage, in a period between time t1′ and t2′, the battery is charged at a constant current of I1′ until the voltage reaches U1′; in a period between time t2′ and t3′, the battery is charged at a constant voltage of U1′, and the corresponding charge current in this period drops from I1′ to I2′; in a period between time t3′ and t4′, the battery is charged at a constant current of I2′ until the voltage reaches U2′; in a period between time t4′ and t5′, the battery is charged at a constant voltage of U2; in a period between time t(i−1)′ and ti′, the battery is charged at a constant current of Ii′ until the voltage reaches Ui; in a period between time ti′ and t(i+1)′, the battery is charged at a constant voltage of Ui′, and the corresponding charge current in this period drops from I1′ to I(i+1); in a period between time t(K−2)′ and t(K−1)′, the battery is charged at a constant current of Im until the voltage reaches Um; and, in a period between time t(K−1)′ and tK′, the battery is charged at a constant voltage of Um, and the corresponding charge current in this period drops from Im to Im′. A similar charging process is performed in a period between time t5′ and t(i−1)′, and in a period between time t(i+1)′ and t(K−2)′, which is omitted from the drawing and not shown.

It needs to be noted that, at each of the K charging sub-stages of the first stage, the battery is charged at a constant charge current and a constant charge voltage alternately, I1≥I2≥ . . . ≥Ic1, and U1≤U2≤ . . . ≤Uc1. At each of the K charging sub-stages of the second stage, the battery is also charged at a constant charge current and a constant charge voltage alternately, I1′≥I2′≥ . . . ≥Im′, U1′≤U2′≤ . . . ≤Um, Ic1≥I1′, and Uc1≤U1′.

When the battery is charged in the second charging manner, the first stage includes D sequential charging sub-stages, D is a positive integer, the D charging sub-stages are defined as an j^{th} charging sub-stage, where j=1, 2, . . . D, respectively, and each j^{th} charging sub-stage includes a j^{th} earlier charging sub-stage and a j^{th} later charging sub-stage. The second stage also includes D sequential charging sub-stages, D is a positive integer, the D charging sub-stages are defined as an j^{th} charging sub-stage, where j=1, 2, . . . D, respectively, and each j^{th} charging sub-stage includes a j^{th} earlier charging sub-stage and a j^{th} later charging sub-stage. It needs to be noted that the number D of charging sub-stages in the first stage may be the same as or different from the number D in the second stage.

At one of the j^{th} earlier charging sub-stage or the j^{th} later charging sub-stage, the battery is not charged or is charged or discharged at a j^{th} earlier charge sub-current for a duration of Tj1; at the other of the j^{th} earlier charging sub-stage or the j^{th} later charging sub-stage, the battery is charged at a j^{th} later charge sub-current for a duration of Tj2; and an absolute value of the j^{th} earlier charge sub-current is less than an absolute value of the j^{th} later charge sub-current.

In other words, at each j^{th} charging sub-stage, the battery is charged by means of pulse charge or pulse charge-and-discharge, and an average of the charge current at the (j+1)^{th} charging sub-stage is less than or equal to the charge current at the j^{th} charging sub-stage. For example, (the 1^{st} earlier charging sub-current×T11+the 1^{st} later charging sub-current×T12)/(T11+T12) is greater than or equal to (the 2^{nd} earlier charging sub-current×T21+2^{nd} later charging sub-current×T22)/(T21+T22), (the 2^{nd} earlier charging sub-current×T21+the 2^{nd} later charging sub-current×T22)/(T21+T22) is greater than or equal to (the 3^{rd} earlier charging sub-current×T31+the 3^{rd} later charging sub-current×T32)/(T31+T32), and so on. Each sum of a Tj1 duration and a Tj2 duration is a charging period or a discharging period of pulse charge or pulse charge-and-discharge at the j^{th} charging sub-stage.

In addition, it needs to be noted that: in this embodiment, at the j^{th} earlier charging sub-stage, the battery is charged or discharged at the j^{th} earlier charging sub-current for a duration of Tj1, and, at the j^{th} later charging sub-stage, the battery is charged at the j^{th} later charging sub-current for a duration of Tj2. In other embodiments, instead, at the j^{th} earlier charging sub-stage, the battery may be charged at the j^{th} later charging sub-current for a duration of Tj2, and, at the j^{th} later charging sub-stage, the battery may be charged or discharged at the j^{th} earlier charging sub-current for a duration of Tj1. In other embodiments, instead, at the j^{th} earlier charging sub-stage, the battery may be not charged or may stand statically (during which the charge current is 0) for a duration of Tj1, and, at the j^{th} later charging sub-stage, the battery may be charged or discharged at the j^{th} later sub-current for a duration of Tj2.

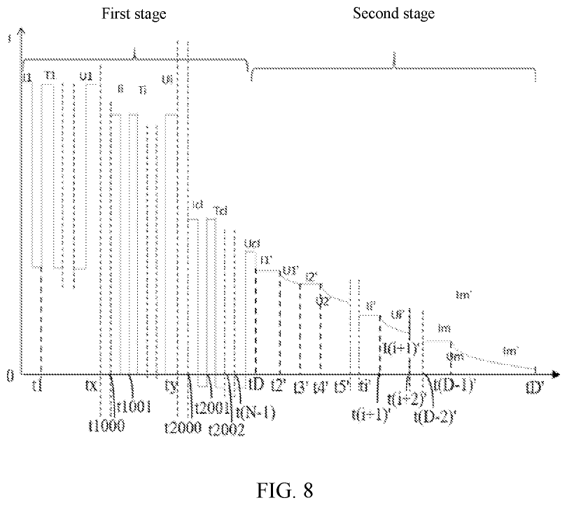

Referring to FIG. 8, in a period between time t1 and t1000, that is, in each charging sub-stage from the first sub-stage to the 1000^{th} charging sub-stage of the first stage, the battery is first charged at a current of I2, and then charged at a current of I3. A similar charging process is performed in a period between time tx and t1000, which is omitted from the drawing and not shown.

In a period between time t1000 and t2000, that is, in each charging sub-stage from the 1001^{st} to the 2000^{th} charging sub-stage of the first stage, the battery is first charged at a current of I10011, and then left to stand (that is, neither charged nor discharged). A similar charging process is performed in a period between time ty and t2000, which is omitted from the drawing and not shown. In a period between time t2000 and tD, that is, in each charging sub-stage from the 2001^{st} charging sub-stage to the D^{th} charging sub-stage of the first stage, the battery is first charged at a current of I20011, and then discharged at a current of I20012 until the voltage of the battery is equal to the voltage Uc1 (that is, the cut-off voltage). A similar charging process is performed in a period between time t2002 and t(K−1), which is omitted from the drawing and not shown.

In other words, in the D charging sub-stages of the first stage, the battery is charged in three different manners of pulse charge or pulse charge-and-discharge. In addition, it needs to be noted that: the charging period or the charge-and-discharge period of pulse charge or pulse charge-and-discharge is the same at each of the D charging sub-stages, that is, t1=(t1001−t1000)=(t2001−t2000). In other embodiments, instead, the charging period or charge-and-discharge period of pulse charge or pulse charge-and-discharge may vary between different charging sub-stages.

At the second stage, in a period between time t1′ and t2′, the battery is charged at a constant current of I1′ until the voltage reaches U1′; in a period between time t2′ and t3′, the battery is charged at a constant voltage of Ur, and the corresponding charge current in this period drops from I1′ to I2′; in a period between time t3′ and t4′, the battery is charged at a constant current of I2′ until the voltage reaches U2′; in a period between time t4′ and t5′, the battery is charged at a constant voltage of U2′; in a period between time ti′ and t(i+1)′, the battery is charged at a constant current of Ii′ until the voltage reaches Ui; in a period between time t(i+1)′ and t(i+2)′, the battery is charged at a constant voltage of Ui′, and the corresponding charge current in this period drops from I1′ to I(i+1); in a period between time t(D−2)′ and t(D−1)′, the battery is charged at a constant current of Im until the voltage reaches Um; and, in a period between time t(D−1)′ and tD′, the battery is charged at a constant voltage of Um, and the corresponding charge current in this period drops from Im to Im′. A similar charging process is performed in a period between time t5′ and ti′, and in a period between time t(i+2)′ and t(D−2)′, which is omitted from the drawing and not shown.

Overall, in the method for enhancing battery cycle performance according to this application, by a first means, the charge voltage limit of the battery is increased from the first-stage voltage to the second-stage voltage. By a second means, a nitrile compound is added into the electrolytic solution at a given mass percent, thereby enhancing the high-temperature cycle performance of the battery while reducing the high-temperature storage expansion rate and enhancing hot-oven safety performance. The two means are not a simple summation of the following two effects: one effect is that the increase of the charge voltage limit shortens the duration of charging the battery to a fully charged state, and the other effect is that the nitrile compound can, at a high voltage, make the positive electrode material form a stable solid electrolyte interphase (SEI) film at a highest-potential local position. The two means combined together produce unexpected results.

To make the objectives, technical solutions, and technical effects of this application clearer, the following describes this application in further detail with reference to drawings and embodiments. Understandably, the embodiments described in this specification are merely intended to interpret this application but not to limit this application. This application is not limited to the embodiments enumerated in the specification. In this embodiment, the additive may include a nitrile compound represented by Structural Formula 1:

NC—R₁₁—CN Formula 1

In Formula 1, R₁₁ is selected from substituted or unsubstituted C₁ to C₁₀ alkylidene or C₁ to C₁₀ alkyleneoxy. A substituent thereof is a halogen atom or at least one of nitro, cyano, carboxyl, or sulfate group. The substituent is at least one of C₁ to C₅ alkylidene, a halogen atom, cyano, carboxyl, sulfate group, or nitro.

In this embodiment, the nitrile compound represented by Structural Formula 1 may be at least one selected from the following compounds:

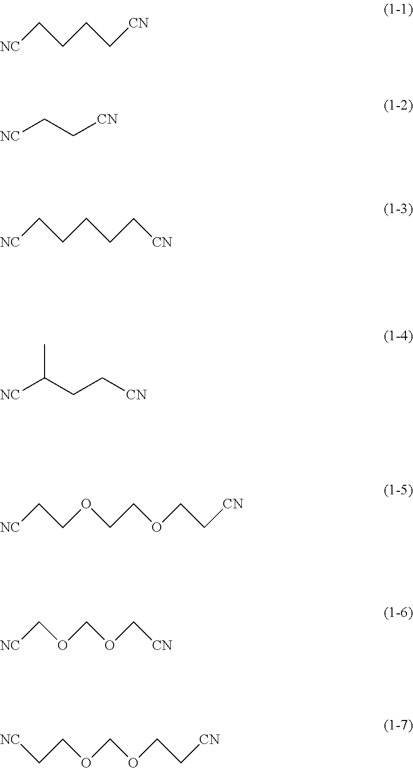

In this embodiment, the additive may include a nitrile compound represented by Structural Formula 2:

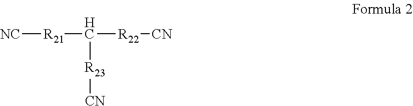

In Formula 2, R₂₁, R₂₂, and R₂₃ each are independently selected from substituted or unsubstituted C₀ to C₁₀ alkylidene or C₁ to C₁₀ alkyleneoxy. A substituent thereof is a halogen atom or at least one of nitro, cyano, carboxyl, or sulfate group. The substituent is at least one of C₁ to C₅ alkylidene, a halogen atom, cyano, carboxyl, sulfate group, or nitro.

In this embodiment, the nitrile compound represented by Structural Formula 2 may be at least one selected from the following compounds:

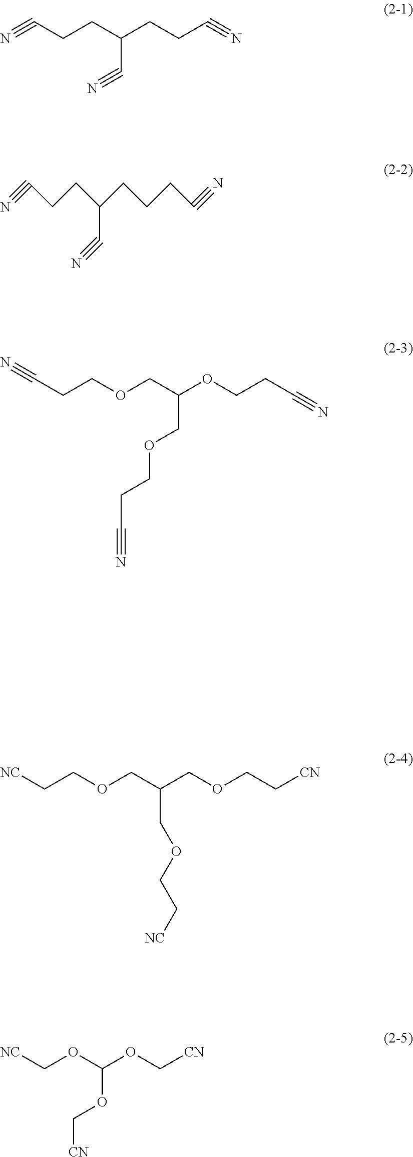 [SMILES: N#CCCC(C#N)CCC#N ; N#CCCCC(C#N)CCC#N ; N#CCCOCC(COCCC#N)OCCC#N ; N#CCCOCC(COCCC#N)COCCC#N ; N#CCOC(OCC#N)OCC#N]

In this embodiment, the additive may include a nitrile compound represented by Structural Formula 3:

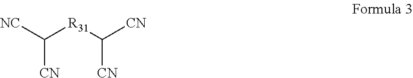

In Formula 3, R₃₁ is selected from substituted or unsubstituted C₁ to C₅ alkyl, substituted or unsubstituted C₂ to C₁₀ alkenyl, substituted or unsubstituted C₆ to C₁₀ aryl, or, substituted or unsubstituted C₁ to C₆ heterocyclic group, of which a substituent is a halogen atom or at least one of nitro, cyano, carboxyl, or sulfate group. The substituent is at least one of C₁ to C₅ alkylidene, a halogen atom, cyano, carboxyl, sulfate group, or nitro.

In this embodiment, the nitrile compound represented by Structural Formula 3 may be at least one selected from the following compounds:

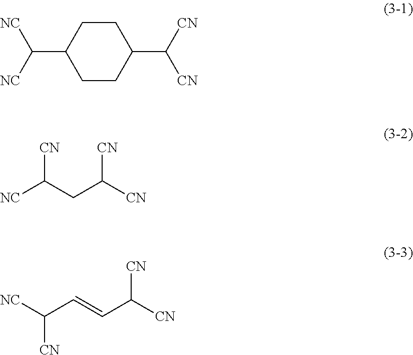 [SMILES: N#CC(C#N)C1CCC(C(C#N)C#N)CC1 ; N#CC(C#N)CC(C#N)C#N ; N#CC(C#N)/C=C/C(C#N)C#N]

In this embodiment, the additive may include at least one of a nitrile compound represented by Structural Formula 1, a nitrile compound represented by Structural Formula 2, or a nitrile compound represented by Structural Formula 3.

In this embodiment, the electrolytic solution may include a nonaqueous organic solvent. The nonaqueous organic solvent may be carbonate, carboxylate, or a combination of both. The carbonate may be any type of carbonate as long as the carbonate can serve as a nonaqueous electrolyte organic solvent, and may be cyclic carbonate, chain carbonate, or the like. The cyclic carbonate may be ethylene carbonate, propylene carbonate, butylene carbonate, γ-butyrolactone, pentylene carbonate, fluoroethylene carbonate, or the like. The chain carbonate may be dimethyl carbonate, diethyl carbonate, dipropyl carbonate, ethyl methyl carbonate, or the like, but without being limited to the items listed above, and may be a halogenated derivative thereof. The carboxylate may be ethyl butyrate, methyl butyrate, propyl propionate, ethyl propionate, methyl propionate, ethyl acetate, methyl acetate, or the like. Such compounds may be used alone or in combination.

In this embodiment, the electrolytic solution may further include other additives. The additives are known by a person skilled in the art to enhance battery performance, for example, an SEI film-forming additive, a flame retardant additive, an anti-overcharge additive, and a conductive additive.

In some embodiments, the electrolytic solution may further include a lithium salt. The lithium salt is at least one selected from inorganic lithium salt or organic lithium salt. Preferably, the lithium salt is at least one selected from lithium hexafluorophosphate (LiPF₆), lithium difluorophosphate (LiPO₂F₂), lithium tetrafluoroborate (LiBF₄), lithium hexafluoroarsenate, lithium perchlorate, lithium bisfluorosulfonimide (LiFSI), lithium bis(trifluoromethanesulfonyl)imide (LiTFSI), lithium bis(oxalato)borate LiB(C₂O₄)₂ (LiBOB for short), or lithium difluoro(oxalato)borate LiBF₂(C₂O₄) (LiDFOB for short). Further preferably, the lithium salt is selected from lithium hexafluorophosphate (LiPF₆).

The following describes the technical solutions of this application with reference to specific embodiments.

### Preparing an Electrolytic Solution

Mixing ethylene carbonate (EC for short), diethyl carbonate (DEC for short), propylene carbonate (PC for short) evenly at a mass ratio of 3:4:3 in an argon atmosphere glovebox in which the moisture content is less than 10 ppm, dissolving thoroughly dried lithium salt LiPF₆ in the foregoing nonaqueous solvent, and finally adding additives at a given mass percent to formulate the electrolytic solution.

The type and mass percent of nitrile compounds in the electrolytic solution as well as the charging manners are adjusted to obtain different electrolytic solutions and/or charging methods described in Comparative Embodiments 1 to 3 and Embodiments 1 to 11.

TABLE 1
Related parameters in Comparative Embodiments 1 to 3 and Embodiments 1 to 11

| | | Nitrile additive | | |
|---|---|---|---|---|
| Solution | Electrolytic solution | Structural formula | Mass percent | Charging manner |
| Comparative | Existing electrolytic solution | / | / | Existing charging manner |
| Embodiment 1 | | | | |
| Comparative | Existing electrolytic solution | / | / | New charging manner 1 |
| Embodiment 2 | | | | |
| Comparative | New electrolytic solution | (1-1) | 2% | Existing charging manner |
| Embodiment 3 | | | | |
| Embodiment 1 | New electrolytic solution | (2-1) | 2% | New charging manner 1 |
| Embodiment 2 | New electrolytic solution | (1-1) | 2% | New charging manner 1 |
| Embodiment 3 | New electrolytic solution | (3-2) | 2% | New charging manner 1 |
| Embodiment 4 | New electrolytic solution | (1-1) | 2% | New charging manner 2 |
| Embodiment 5 | New electrolytic solution | (1-1) | 2% | New charging manner 3 |
| Embodiment 6 | New electrolytic solution | (1-1) | 2% | New charging manner 4 |
| Embodiment 7 | New electrolytic solution | (1-1) | 2% | New charging manner 5 |
| Embodiment 8 | New electrolytic solution | (1-1) | 0.01% | New charging manner 1 |
| Embodiment 9 | New electrolytic solution | (1-1) | 10% | New charging manner 1 |
| Embodiment 10 | New electrolytic solution | (1-1) | 0.50% | New charging manner 1 |
| Embodiment 11 | New electrolytic solution | (1-1) | 5% | New charging manner 1 |

The battery system adopted in the comparative embodiments and the embodiments uses lithium cobalt oxide as a positive electrode, and uses graphite as a negative electrode. The battery system further includes a separator, an electrolytic solution, and a packaging shell, and is prepared through processes such as mixing, coating, assembling, chemical formation, and aging. The positive electrode is made of 96.7 wt % LiCoO₂ (serving as a positive active material) mixed with 1.7 wt % polyvinylidene difluoride (PVDF, serving as a binder) plus 1.6 wt % UPER-P acetylene conductive carbon black (SP, serving as a conductive agent). The negative electrode is made of 98 wt % artificial graphite (serving as a negative active material) mixed with 1.0 wt % styrene butadiene rubber (SBR, serving as a binder) plus 1.0 wt % sodium carboxymethyl cellulose (CMC, serving as a thickener). The separator is a PP/PE/PP composite film.

The existing electrolytic solution described in the Comparative Embodiments 1 to 2 is made of an organic solvent (30 wt % ethylene carbonate+30 wt % propylene carbonate+40 wt % diethyl carbonate) mixed with 1 mol/L lithium hexafluorophosphate, and blended with additives (0.5 wt % vinylene carbonate, 5 wt % fluorinated ethylene carbonate, and 4 wt % vinyl ethylene carbonate). The mass percent of the nitrile compound in the existing electrolytic solution described in Comparative Embodiments 1 to 2 is 0. The new electrolytic solution described in Comparative Embodiment 3 and Embodiments 1 to 11 is prepared by adding a given amount of nitrile compound into an existing electrolytic solution, where the structural formula of the nitrile compound may be Structural Formula (1-1), or Structural Formula (2-1), or Structural Formula (3-2). Evidently, the structural formula of the nitrile compound in this embodiment is not limited to Structural Formula (1-1), Structural Formula (2-1), and Structural Formula (3-2) above, but may be a combination of any two or more of Structural Formula (1-1), Structural Formula (2-1), or Structural Formula (3-2), or may be a combination of any one or more of remaining compounds derived from Formula 1, Formula 2, and Formula 3. The mass percent of the nitrile compound is shown in Table 1.

In Comparative Embodiment 1 and Comparative Embodiment 3, the battery is charged by an existing charging manner. Specific steps of the existing charging manner are as follows:

Under an ambient temperature of 45° C.:

Step 1: Charging the battery at a constant current of 0.7 C until the voltage reaches 4.4 V;

Step 2: Charging the battery at a constant voltage of 4.4 V until the current reaches 0.05 C;

Step 3: Leaving the battery to stand for 5 minutes;

Step 4: Discharging the battery at a constant current of 0.5 C until the voltage reaches 3.0 V;

Step 5: Leaving the battery to stand for 5 minutes; and

Step 6: Repeating steps 1 to 5 to complete 500 cycles.

C is a numeral value corresponding to the capacity of the lithium-ion battery. The capacity of a lithium-ion battery is generally expressed in Ah or mAh. For example, when the battery capacity is 1200 mAh, 1 C is 1200 mA, and 0.2 C is equal to 240 mA.

The charging manner applied in Comparative Embodiment 2 and Embodiments 1 to 11 is a new charging manner according to this application. The charging manner applied in Comparative Embodiment 2, Embodiments 1 to 3, and Embodiments 8 to 11 is anew charging manner 1 according to this application, and the specific process of the charging manner is as follows:

Under an ambient temperature of 45° C.:

Step 1: Charging the battery at a constant current of 0.7 C until the voltage reaches 4.4 V;

Step 2: Charging the battery at a constant current of 0.5 C until the voltage reaches 4.45 V;

Step 3: Charging the battery at a constant voltage of 4.45 V until the current reaches 0.12 C;

Step 4: Leaving the battery to stand for 5 minutes;

Step 5: Discharging the battery at a constant current of 0.5 C until the voltage reaches 3.0 V;

Step 6: Leaving the battery to stand for 5 minutes; and

Step 7: Repeating steps 1 to 6 to complete 500 cycles.

The charging manner applied in Embodiment 4 is a new charging manner 2, and the specific process of the charging manner is as follows:

Under an ambient temperature of 45° C.:

Step 1: Charging the battery at a constant current of 0.7 C until the voltage reaches 4.4 V;

Step 2: Charging the battery at a constant current of 0.5 C until the voltage reaches 4.45 V;

Step 3: Charging the battery at a constant current of 0.4 C until the voltage reaches 4.54 V;

Step 4: Leaving the battery to stand for 5 minutes;

Step 5: Discharging the battery at a constant current of 0.5 C until the voltage reaches 3.0 V;

Step 6: Leaving the battery to stand for 5 minutes; and

Step 7: Repeating steps 1 to 6 to complete 500 cycles.

The charging manner applied in Embodiment 5 is a new charging manner 3, and the specific process of the charging manner is as follows:

Under an ambient temperature of 45° C.:

Step 1: Charging the battery at a constant current of 0.7 C until the voltage reaches 4.4 V;

Step 2: Charging the battery at a constant voltage of 4.35 V until the current reaches 0.4 C;

Step 3: Charging the battery at a constant voltage of 4.45 V until the current reaches 0.13 C;

Step 4: Leaving the battery to stand for 5 minutes;

Step 5: Discharging the battery at a constant current of 0.5 C until the voltage reaches 3.0 V;

Step 6: Leaving the battery to stand for 5 minutes; and

Step 7: Repeating steps 1 to 6 to complete 500 cycles.

The charging manner applied in Embodiment 6 is a new charging manner 4, and the specific process of the charging manner is as follows:

Under an ambient temperature of 45° C.:

Step 1: Charging the battery at a constant current of 0.7 C (2.1 A) until the voltage reaches 4.4 V;

Step 2: Charging the battery at a constant power of 7 W until the voltage reaches 4.45 V;

Step 3: Charging the battery at a constant power of 5.5 W until the voltage reaches 4.55 V;

Step 4: Leaving the battery to stand for 5 minutes;

Step 5: Discharging the battery at a constant current of 0.5 C until the voltage reaches 3.0 V;

Step 6: Leaving the battery to stand for 5 minutes; and

Step 7: Repeating steps 1 to 6 to complete 500 cycles.

The charging manner applied in Embodiment 7 is a new charging manner 5, and the specific process of the charging manner is as follows:

Under an ambient temperature of 45° C.:

Step 1: Charging the battery at a constant current of 0.7 C until the voltage reaches 4.4 V;

Step 2: Leaving the battery to stand for 2.9 seconds;

Step 3: Charging the battery at a constant current of 0.7 C for 7.1 seconds; determining whether the voltage of the battery is greater than or equal to 4.45 V. When the voltage of the battery is greater than or equal to 4.45 V, proceeding to step 5;

Step 4: Repeating steps 2 to 3 to complete 100000 cycles;

Step 5: Discharging the battery at a constant current of 0.05 C for 1 second;

Step 6: Charging the battery at a constant current of 0.41 C for 9 seconds, and determining whether the voltage of the battery is greater than or equal to 4.54 V. When the voltage of the battery is greater than or equal to 4.54 V, proceeding to step 8; and

Step 7: Repeating steps 5 to 6 to complete 100000 cycles.

Performing tests on Comparative Embodiments 1 to 3 and Embodiments 1 to 11, and test results are shown in Table 2.

TABLE 2
Test results of Comparative
Embodiments 1 to 3 and Embodiments 1 to 11

| | Cycle performance | | | |
|---|---|---|---|---|
| | comparison of batteries | | | |
| Solution | X1 | X2 | X3 | X4 |
| Comparative Embodiment 1 | 72.3% | 14.1% | 83.8% | 74% |
| Comparative Embodiment 2 | 80.4% | 15.0% | 82.9% | 70% |
| Comparative Embodiment 3 | 78.2% | 13.4% | 85.3% | 76% |
| Embodiment 1 | 90.0% | 8.5% | 93.8% | 100% |
| Embodiment 2 | 90.6% | 8.6% | 92.3% | 100% |
| Embodiment 3 | 90.4% | 8.4% | 92.7% | 100% |
| Embodiment 4 | 91.1% | 8.4% | 93.4% | 99% |
| Embodiment 5 | 89.5% | 8.7% | 91.2% | 97% |
| Embodiment 6 | 88.9% | 9.2% | 90.1% | 98% |
| Embodiment 7 | 90.3% | 9.3% | 92.9% | 96% |
| Embodiment 8 | 82.2% | 12.9% | 86.6% | 85% |
| Embodiment 9 | 81.0% | 12.6% | 87.6% | 84% |
| Embodiment 10 | 87.2% | 10.9% | 88.7% | 93% |
| Embodiment 11 | 84.3% | 12.7% | 87.4% | 94% |

In Table 2, X1 is a capacity retention rate at the end of charge-and-discharge cycles. A method for calculating the capacity retention rate at the end of charge-and-discharge cycles is: performing 500 charge-and-discharge cycles on the batteries in the comparative embodiments and the embodiments by performing corresponding charging processes under an ambient temperature of 45° C., and dividing a discharge capacity of a battery at the end of the 500^{th} cycle by a discharge capacity at the end of the 1^{st} cycle to obtain the capacity retention rate.

In Table 2, X2 is a thickness growth rate of the battery. The thickness growth rate of a battery is measured in the following process: charging and discharging the battery for 500 cycles according to the corresponding charging processes described in the comparative embodiments and the embodiments under a 25° C. environment (for both the comparative embodiments and the embodiments) before the battery is subjected to a cycle test. Measuring a thickness H1 of the battery at this time by using a parallel plate gauge. Moving the battery into a 60° C. muffle oven to store the battery for 7 days after completion of 500 cycles. Taking out the battery after 7 days of storage and leaving the battery to stand for 2 hours. Measuring the thickness H2 of the battery at the end of the 2 hours of standing by using the parallel plate gauge, and then calculating the thickness growth rate of the battery according to the following formula: thickness growth rate of the battery=(H2−H1)/H1×100%.

In Table 2, X3 is a reversible capacity retention rate of the battery. The reversible capacity retention rate of a battery is determined in the following way: discharging the battery at a current of 0.5 C until the voltage reaches 3.0 V under a 25° C. environment before the battery is subjected to a cycle test (for both the comparative embodiments and the embodiments), and using a discharge capacity at the end of the discharge as a reference capacity. Leaving the battery to stand for 5 minutes, and charging and discharging the battery for 500 cycles according to the corresponding charging processes described in the comparative embodiments and the embodiments. Leaving the battery to stand for 5 minutes after completion of the 500 cycles. Discharging the battery again at a current of 0.5 C until the voltage reaches 3.0 V. Calculating a difference between the first-cycle discharge capacity and a discharge capacity in this step, and dividing the difference by the first-cycle discharge capacity to obtain the reversible capacity retention rate of the battery.

The specific process is as follows:

Under an ambient temperature of 25° C.:

Step 1: Charging the battery at a constant current of 0.2 C until the voltage reaches 4.4 V;

Step 2: Charging the battery at a constant voltage of 4.4 V until the current reaches 0.05 C;

Step 3: Discharging the battery at a constant current of 0.5 C until the voltage reaches 3.0 V (calculating a discharge capacity in this step, and using the discharge capacity in this step as a reference capacity);

Step 4: Leaving the battery to stand for 5 minutes;

Step 5: Completing 500 cycles according to the test processes described in the comparative embodiments and the embodiments;

Step 6: Leaving the battery to stand for 5 minutes; and

Step 7: Discharging the battery at a constant current of 0.5 C until the voltage reaches 3.0 V (calculating a discharge capacity in this step, calculating a difference between the discharge capacity obtained in step 3 and a discharge capacity obtained in this step, and dividing the difference by the discharge capacity obtained in step 3, thereby obtaining the reversible capacity retention rate of the battery).

In Table 2, X4 is a hot oven test pass rate of the battery. The hot oven test pass rate of the battery is determined in the following way: testing batteries in groups, where each group includes 100 batteries; completing 500 cycles for the batteries according to the test processes described in the comparative embodiments and the embodiments, and then moving the batteries into a hot oven. Increasing the temperature to 130° C. in the hot oven at a speed of 3° C./min. Leaving the hot oven to stay at 130° C. for 1 hour, and then naturally cooling down to a room temperature. Counting the number of batteries that do not catch fire or explode at this time, dividing the number Z1 by 100 to obtain a hot oven test pass rate of the battery.

As can be seen from the test result of Comparative Embodiment 1, when the conventional electrolytic solution and the conventional constant-current and constant-voltage charging manner are applied, the constant-voltage charging lasts for a relatively long time, and gradually damages the positive electrode material during cycles, resulting in a low capacity retention rate. In addition, after completion of a given number of cycles, the thermal stability of the battery is poor. The battery thickness expands greatly in a test such as storing the battery at 60° C. for 7 days in a fully charged state, and the pass rate of the battery is relatively low in a hot oven test in which the battery is stored at 130° C. in a hot oven for 1 hour to check whether the battery catches fire or explodes.

As can be seen from the test results of Comparative Embodiment 2 and Comparative Embodiment 1, the new charging manner can improve the capacity retention rate of battery cells after cycles, but without significantly improving the thermal stability of the battery cells after cycles. A main reason is that the new charging manner can significantly shorten the duration of charging the battery to a fully charged state and alleviate the damage to the positive electrode during cycles. However, the accelerated charging speed increases the temperature of the battery cells to a relatively high level, and aggravates production of by-products, so that the new charging manner does not significantly improve the low-temperature discharge performance of the battery after cycles.

As can be seen from the test results of Comparative Embodiment 3 and Comparative Embodiment 1, the new electrolytic solution improves the cycle performance of the battery cells to some extent, and slightly improves the thermal stability of the battery cells after cycles. A main reason is that although the added nitrile compound can alleviate polarization, the constant-current and constant-voltage charging manner in the prior art causes the positive electrode of the battery to stay under a high voltage for a long time, and already causes damage to the positive electrode material to some extent. Therefore, the new electrolytic solution merely slightly improves the thermal stability of the battery cells after cycles.

As can be seen from the test results of Embodiment 1, Embodiment 2, and the comparative embodiments, the new electrolytic solution is used together with the new charging manner to significantly improve the cycle capacity retention rate of the battery cells and the thermal stability of the battery after cycles, and especially, ensure that the hot oven test pass rate is close to 100%. A main reason is that the new charging manner can significantly shorten the duration of charging the battery to a fully charged state under a high voltage. The added nitrile compound can alleviate the damage caused by the high voltage to the positive electrode of the battery. Therefore, throughout the cycles, the damage to the positive electrode of the battery is alleviated significantly, and the side reactions are reduced, thereby significantly improving the capacity retention rate of the battery after cycles and the hot oven test pass rate of the battery after cycles.

As can be seen from the test results of Embodiments 2 to 6, different new charging manners used together with the new electrolytic solution can significantly improve the cycle performance of the battery cells and the thermal stability of the battery after cycles. A main reason is that the new charging manner can significantly shorten the duration of charging the battery to a fully charged state under a high voltage. The added nitrile compound can alleviate the damage caused by the high voltage to the positive electrode of the battery. Therefore, throughout the cycles, the damage to the positive electrode of the battery is alleviated significantly, and the side reactions are reduced, thereby significantly improving the capacity retention rate of the battery after cycles and the hot oven test pass rate of the battery after cycles.

As can be seen from the test results of Embodiment 2 and Embodiments 7 to 10, the new electrolytic solution contains a 0.01 wt % to 10 wt % nitrile compound and is used together with the new charging manner, thereby improving the cycle performance of the battery cells and the thermal stability of the battery cells after cycles. In an embodiment, a mass percent of the nitrile compound in the electrolytic solution is 0.5% to 5%. Preferably, the mass percent of the nitrile compound in the electrolytic solution is 0.5% to 3%.

The nitrile compound can form a stable SEI (solid electrolyte interphase) film on the positive electrode to protect the positive electrode material. The charging manner according to this application can raise the charge voltage limit, shorten the duration of charging the battery to a fully charged state, and in turn, shorten the time of the positive electrode staying at a high potential, thereby improving the cycle. performance. However, a fast flash charge (FFC) charging manner impairs the stability of the local positive electrode material in the battery to some extent while raising the charge voltage limit, thereby deteriorating the thermal stability of the battery after cycles. In the technical solution disclosed herein, the electrolytic solution containing a nitrile compound is used together with the new charging manner to achieve a technical effect, and the technical effect is not achievable by simply adding the effect of the nitrile compound to the effect of the new charging manner according to this application. Further, the technical solution disclosed herein significantly alleviates the problem of local damage caused by the high voltage to the battery cells, achieves an unexpected effect, and significantly improves the cycle capacity retention rate of the battery and the thermal stability of the battery after the battery undergoes a given number of cycles. Neither the nitrile compound alone nor the new charging manner alone can significantly improve the cycle capacity retention rate of the battery, or significantly improve the thermal stability of the battery after the battery undergoes a given number of cycles. Therefore, the combination of the nitrile compound and the new charging manner according to this application can achieve unexpected effects.

According to this application, the mass percent of the nitrile compound in the electrolytic solution of the battery is adjusted, and the adjusted battery is charged in two stages. At the first stage, the adjusted battery is charged at a constant current, a constant voltage, or a constant power, or at least one thereof until the voltage reaches the first-stage voltage. At the second stage, the adjusted battery is charged at a constant current, a constant voltage, or a constant power, or at least one thereof. Alternatively, a charging manner of pulse charge or pulse charge-and-discharge may be adopted at the first stage and the second stage. In this way, the cycle performance of the battery can be further enhanced, and the capacity retention rate of the battery after cycles and the hot oven test pass rate of the battery after cycles can be improved significantly.

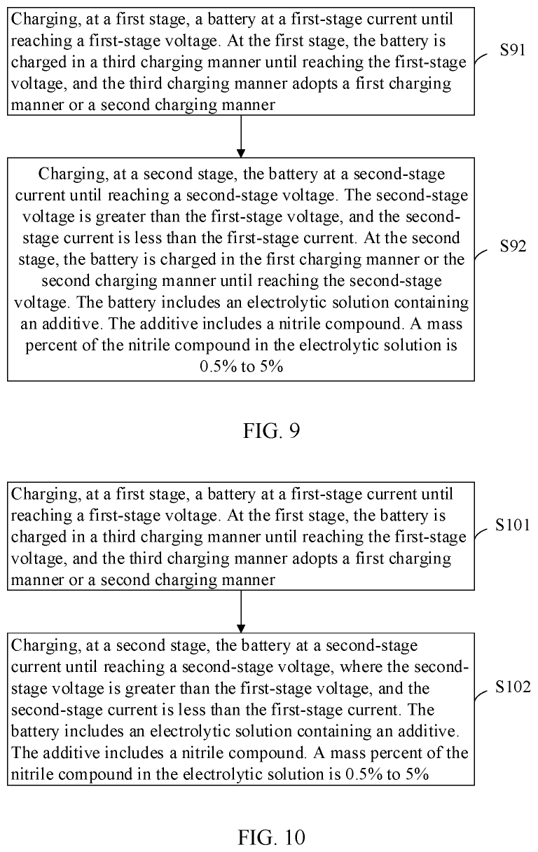

Referring to FIG. 9, FIG. 9 is a second specific embodiment of the method for enhancing battery cycle performance shown in FIG. 2. The second specific embodiment is similar to the first specific embodiment, and the second specific embodiment also includes step S91 and step S92. The difference lies in step S91, as detailed below:

S91: Charging, at a first stage, the battery at a first-stage current until reaching a first-stage voltage. At the first stage, the battery is charged in a third charging manner until reaching the first-stage voltage, and the third charging manner adopts the first charging manner or the second charging manner.

In this embodiment, the first charging manner and the second charging manner are the same as the first charging manner and the second charging manner described in the first specific embodiment, and are not repeated herein.

When the third charging manner adopts the first charging manner, the number K of charging sub-stages may be identical between the two manners. To be specific, the number of charging sub-stages included in the first charging manner adopted at the first stage may be the same as the number of charging sub-stages included in the first charging manner adopted at the second stage. Alternatively, when the third charging manner adopts the second charging manner, the number D of charging sub-stages may be identical between the two manners. To be specific, the number of charging sub-stages included in the second charging manner adopted at the first stage may be the same as the number of charging sub-stages included in the second charging manner adopted at the second stage.

When the third charging manner adopts the first charging manner, the number K of charging sub-stages may be different between the two manners. To be specific, the number of charging sub-stages included in the first charging manner adopted at the first stage may be different from the number of charging sub-stages included in the first charging manner adopted at the second stage. Alternatively, when the third charging manner adopts the second charging manner, the number D of charging sub-stages may be different between the two manners. To be specific, the number of charging sub-stages included in the second charging manner adopted at the first stage may be different from the number of charging sub-stages included in the second charging manner adopted at the second stage.

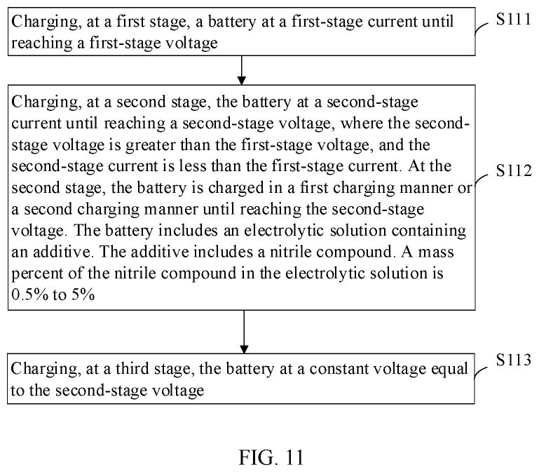

Referring to FIG. 10, FIG. 10 is a third specific embodiment of the method for enhancing battery cycle performance shown in FIG. 2. The third specific embodiment is similar to the first specific embodiment, and the third specific embodiment also includes step S101 and step S102. The difference lies in step S101 and step S102, as detailed below:

Step S101: Charging, at a first stage, the battery at a first-stage current until reaching a first-stage voltage. At the first stage, the battery is charged in a third charging manner until reaching the first-stage voltage, and the third charging manner adopts the first charging manner or the second charging manner.

In this embodiment, the first charging manner and the second charging manner are the same as the first charging manner and the second charging manner described in the first specific embodiment, and are not repeated herein.

Step S102: Charging, at a second stage, the battery at a second-stage current until reaching a second-stage voltage, where the second-stage voltage is greater than the first-stage voltage, and the second-stage current is less than the first-stage current.

The battery includes an electrolytic solution containing an additive. The additive includes a nitrile compound. A mass percent of the nitrile compound in the electrolytic solution is 0.5% to 5%.

In this embodiment, the second-stage current is a constant current, and specifically, a constant current at which the battery is charged at the start of an existing charging process. Alternatively, the second-stage current may be a varying current. For example, at the second stage, the battery is charged at a constant voltage, and therefore, the charge current corresponding to the constant voltage (that is, the second-stage current) is variable as long as the battery can be charged to reach the second-stage voltage by using the second-stage current.

In this embodiment, the battery includes an electrolytic solution containing an additive. The additive includes a nitrile compound. A mass percent of the nitrile compound in the electrolytic solution is 0.5% to 5%. Details are the same as those in the first specific embodiment, in which the battery includes an electrolytic solution containing an additive, the additive includes a nitrile compound, a mass percent of the nitrile compound in the electrolytic solution is 0.5% to 5%. The details are not repeated herein.

Referring to FIG. 11, FIG. 11 is a fourth specific embodiment of the method for enhancing battery cycle performance shown in FIG. 2. The fourth specific embodiment is similar to the first specific embodiment, and the fourth specific embodiment also includes step S111 and step S112. The difference is that the fourth specific embodiment further includes step S113, as detailed below:

Step 113: Charging, at a third stage, the battery at a constant voltage equal to the second-stage voltage.

In this embodiment, at the third stage, the battery is charged at a constant voltage equal to the second-stage voltage until the battery is fully charged.

In other embodiments, the second specific embodiment may be improved with reference to the fourth embodiment by adding step S113: Charging, at a third stage, the battery at a constant voltage equal to the second-stage voltage.

In other embodiments, if the second-stage current at the second stage in the third specific embodiment is a constant current, the third specific embodiment may be improved with reference to the fourth embodiment by adding step S113: Charging, at a third stage, the battery at a constant voltage equal to the second-stage voltage.

To a person skilled in the art, it is evident that this application is not limited to the details of the exemplary embodiments described above, and this application can be implemented in other specific forms without departing from the spirit or essential features of this application. Therefore, the foregoing embodiments of this application are construed in all respects as exemplary but not restrictive. The scope of this application is defined by the claims appended hereto rather than the foregoing description. Therefore, all changes that fall within the meanings and scope of equivalents of the claims are intended to be incorporated in this application.

1. A method for enhancing battery cycle performance, applied in a battery, wherein the method comprises the following steps:
at a first stage, charging the battery at a first-stage current until reaching a first-stage voltage; and
at a second stage, charging the battery at a second-stage current until reaching a second-stage voltage, wherein the second-stage voltage is greater than the first-stage voltage, and the second-stage current is less than the first-stage current,
wherein, the battery comprises an electrolytic solution containing an additive, the additive comprises a nitrile compound, and a mass percent of the nitrile compound in the electrolytic solution is 0.5% to 5%.

2. The method according to claim 1, wherein the additive comprises a nitrile compound represented by Structural Formula 1:
NC—R₁₁—CN Formula 1,
wherein, R₁₁ is selected from substituted or unsubstituted C₁ to C₁₀ alkylidene or C₁ to C₁₀ alkyleneoxy.

3. The method according to claim 1, wherein the additive comprises a nitrile compound represented by Structural Formula 2: 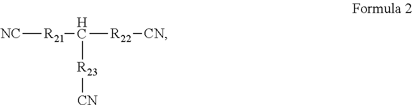
wherein, R₂₁, R₂₂, and R₂₃ each are independently selected from substituted or unsubstituted C₀ to C₁₀ alkylidene or C₁ to C₁₀ alkyleneoxy.

4. The method according to claim 1, wherein the additive comprises a nitrile compound represented by Structural Formula 3: 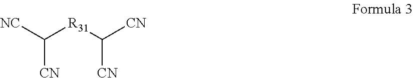
wherein, R₃₁ is selected from substituted or unsubstituted C₁ to C₅ alkyl, substituted or unsubstituted C₂ to C₁₀ alkenyl, substituted or unsubstituted C₆ to C₁₀ aryl, or, substituted or unsubstituted C₁ to C₆ heterocyclic group, of which a substituent is a halogen atom or at least one of nitro, cyano, carboxyl, or sulfate group.

5. The method according to claim 1, wherein at the second stage, the battery is charged in a first charging manner or a second charging manner until reaching the second-stage voltage;
the first charging manner comprises K sequential sub-stages, wherein K is an integer greater than or equal to 2, the K sub-stages are defined as an i^{th} sub-stage, wherein i=1, 2, . . . K, respectively; at the i^{th} sub-stage, the battery is charged at an i^{th} current or an i^{th} voltage or an i^{th} power; at an (i+1)^{th} sub-stage, the battery is charged at an (i+1)^{th} current or an (i+1)^{th} voltage or an (i+1)^{th} power; and, a charge current at the (i+1)^{th} sub-stage is less than or equal to the charge current at the i^{th} sub-stage, or the (i+1)^{th} voltage is greater than or equal to the i^{th} voltage, or the (i+1)^{th} power is less than or equal to the i^{th} power; and
the second charging manner comprises D sequential charging sub-stages, wherein D is an integer greater than or equal to 2, the D charging sub-stages are defined as a j^{th} charging sub-stage, wherein j=1, 2, . . . D, respectively, each j^{th} charging sub-stage comprises a j^{th} earlier charging sub-stage and a j^{th} later charging sub-stage; at one of the j^{th} earlier charging sub-stage or the j^{th} later charging sub-stage, the battery is not charged or is charged or discharged at a j^{th} earlier charge sub-current for a duration of Tj1; at the other of the j^{th} earlier charging sub-stage or the j^{th} later charging sub-stage, the battery is charged at a j^{th} later charge sub-current for a duration of Tj2; and an absolute value of the j^{th} earlier charge sub-current is less than an absolute value of the j^{th} later charge sub-current.

6. The method according to claim 5, wherein, at the second stage, the battery is charged in the second charging manner until reaching the second-stage voltage, an average value of the charge current at the j^{th} charging sub-stage is less than the charge current at the first stage, and an average value of the charge current at the (j+1)^{th} charging sub-stage is less than or equal to the charge current at the j^{th} charging sub-stage.

7. The method according to claim 5, wherein, at the first stage, the battery is charged in a third charging manner until reaching the first-stage voltage, and the third charging manner adopts the first charging manner or the second charging manner.

8. The method according to claim 7, wherein, when the third charging manner adopts the first charging manner, the number K of charging sub-stages is identical between the two manners; or, when the third charging manner adopts the second charging manner, the number D of charging sub-stages is identical between the two manners.

9. The method according to claim 1, wherein the first-stage voltage is equal to a charge voltage limit of the battery, and the second-stage voltage is less than an oxidative decomposition voltage of the electrolytic solution in the battery.

10. The method according to claim 1, wherein the second-stage voltage is less than or equal to the first-stage voltage plus 500 millivolts.

11. An electronic device, comprising a battery and a battery management unit, wherein the battery comprises an electrolytic solution containing an additive, the additive comprises a nitrile compound, a mass percent of the nitrile compound in the electrolytic solution is 0.5% to 5%, and the battery management unit is configured to execute a method for enhancing battery cycle performance, wherein the method comprises the following steps:
at a first stage, charging the battery at a first-stage current until reaching a first-stage voltage; and
at a second stage, charging the battery at a second-stage current until reaching a second-stage voltage, wherein the second-stage voltage is greater than the first-stage voltage, and the second-stage current is less than the first-stage current.

12. The electronic device according to claim 11, wherein the additive comprises a nitrile compound represented by Structural Formula 1:
NC—R₁₁—CN Formula 1,
wherein, R₁₁ is selected from substituted or unsubstituted C₁ to C₁₀ alkylidene or C₁ to C₁₀ alkyleneoxy.

13. The electronic device according to claim 11, wherein the additive comprises a nitrile compound represented by Structural Formula 2: 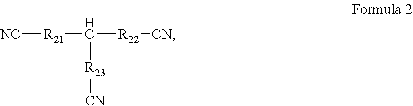
wherein, R₂₁, R₂₂, and R₂₃ each are independently selected from substituted or unsubstituted C₀ to C₁₀ alkylidene or C₁ to C₁₀ alkyleneoxy.

14. The electronic device according to claim 11, wherein the additive comprises a nitrile compound represented by Structural Formula 3: 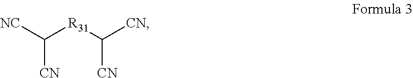
wherein, R₃₁ is selected from substituted or unsubstituted C₁ to C₅ alkyl, substituted or unsubstituted C₂ to C₁₀ alkenyl, substituted or unsubstituted C₆ to C₁₀ aryl, or, substituted or unsubstituted C₁ to C₆ heterocyclic group, of which a substituent is a halogen atom or at least one of nitro, cyano, carboxyl, or sulfate group.

15. The electronic device according to claim 11, wherein the first-stage voltage is equal to a charge voltage limit of the battery, and the second-stage voltage is less than an oxidative decomposition voltage of the electrolytic solution in the battery.

16. The electronic device according to claim 11, wherein the second-stage voltage is less than or equal to the first-stage voltage plus 500 millivolts.
